(19) United States
(12) Patent Application Publication
(10) Pub. No.: US 2021/0194165 A1
(43) Pub. Date: Jun. 24, 2021

(54) FLEXIBLE ELECTRICAL CONTACT WITH INTERCHANGEABLE INTERFACE

(71) Applicant: Hachadorian Design & Calculation GmbH, Frankfurt am Main (DE)

(72) Inventor: Gary Hachadorian, Frankfurt am Main (DE)

(21) Appl. No.: 16/761,288

(22) PCT Filed: Nov. 9, 2018
(86) PCT No.: PCT/EP2018/080750

§ 371 Date: May 4, 2020

Related U.S. Application Data
(60) Provisional application No. 62/583,798, filed on Nov. 9, 2017.

(51) Int. Cl. H01R 13/05; H01R 13/11; H01R 13/405; H01R 43/16

(52) U.S. Cl. CPC H01R 13/052; H01R 43/16; H01R 13/405; H01R 13/111

(57) ABSTRACT

The present system is directed in various methods, devices and systems relating to an improved electrical contact for an electrical connection. The electrical contacts of the present invention may comprise a flexible region, interface region and connection region wherein the flexible region may be integrated with the interface region or the connection region. The flexible region, connection region and/or interface region may comprise different materials and/or different surface treatments.

### CROSS-REFERENCE TO RELATED APPLICATIONS

This application claims the benefit of U.S. Provisional Application Ser. No. 62/583,798, filed Nov. 9, 2017 and entitled FLEXIBLE CONTACT WITH INTERCHANGEABLE INTERFACE, the entirety is which is incorporated herein by reference.

### FIELD OF THE INVENTION

The invention relates generally to the provision of electric contacts that, when connected, form an electrical connection.

### BACKGROUND

Electrical contacts with turned contact pin riveted to a stamped-formed crimping region are known in the art. See, e.g., the flex-contact design 10 of DE 10 2010 038 498 B4, illustrating an electrical contact as in FIG. 1 and comprising a connection region 12, a flexible region 14 and interface region 16. See also related U.S. patent application Ser. No. 13/823,033. Some advantages of this design may include: damage resistance against poorly made spiral connection cables (plug connector with socket contacts); damage resistance against misaligned or rigidly-fixed interfacing contacts; resistance against extreme cases of wear; as opposed to loose-turned contacts, delivered individually in bulk, the turned contacts riveted to a stamped and formed crimping region may be attached to wires with an automated process and/or machine; and/or the solid design of the turned contact pin may act as an electrical dampener to reduce the effects of power surges.

It would be desirable to provide, inter alia, an electrical contact that comprises one or more of interchangeability of contact parts, overmolding of the connection region and/or interface region, and a flexible region that may be integrated with either the interface region or the connection region as well as a sealing region to facilitate chemical bonding.

The present invention overcomes these deficiencies and provides, inter alia, the above-referenced improvements.

### BRIEF SUMMARY OF THE INVENTION

The present system is directed in various methods, devices and systems relating to an improved electrical contact for an electrical connection. The electrical contacts of the present invention may comprise a flexible region, interface region and connection region wherein the flexible region may be integrated with the interface region or the connection region. The flexible region, connection region and/or interface region may comprise different materials and/or different surface treatments.

### BRIEF DESCRIPTION OF THE DRAWINGS

FIG. 1 is a known electrical contact.

FIG. 2 is a side view of one embodiment of the present invention.

FIG. 3 is a side view of one embodiment of the present invention.

FIG. 4A is a perspective view of one embodiment of the present invention.

FIG. 4B is a perspective view of one embodiment of the present invention.

FIG. 5A is a perspective view of one embodiment of the present invention.

FIG. 5B is a perspective cross-sectional view of one embodiment of the present invention.

FIG. 6A is a perspective view of one embodiment of the present invention.

FIG. 6B is a perspective cross-sectional view of one embodiment of the present invention.

FIG. 7A is a perspective view of one embodiment of the present invention.

FIG. 7B is a perspective cross-sectional view of one embodiment of the present invention.

FIG. 8A is a perspective view of one embodiment of the present invention.

FIG. 8B is a perspective cross-sectional view of one embodiment of the present invention.

FIG. 9A is a side cross-sectional view of one embodiment of the present invention.

FIG. 9B is a side cross-sectional view of one embodiment of the present invention.

FIG. 10 is a side cross-sectional view of one embodiment of the present invention.

FIG. 11 is a perspective exploded view of one embodiment of the present invention.

FIG. 12 is a perspective exploded view of one embodiment of the present invention.

FIG. 13 is a perspective cross-sectional view of one embodiment of the present invention.

FIG. 14 is a perspective cross-sectional view of one embodiment of the present invention.

FIG. 15A is a perspective view of one embodiment of the present invention.

FIG. 15B is a perspective exploded view of one embodiment of the present invention.

FIG. 16A is a perspective view of one embodiment of the present invention.

FIG. 16B is a perspective exploded view of one embodiment of the present invention.

FIGS. 17A-17H are perspective views of embodiments of the present invention.

FIGS. 18A-18E are perspective views of embodiments of the present invention.

FIGS. 19A-19C are perspective views of embodiments of the present invention.

FIGS. 20A-20B are perspective views of embodiments of the present invention.

FIG. 20C-20D are perspective cross-sectional views of embodiments of the present invention.

FIGS. 21A-21C are perspective views of manufacturing of embodiments of the present invention from stamped material.

FIG. 22A is a perspective view of a connection region of the present invention.

FIG. 22B is a side view of an embodiment of the present invention.

FIG. 23A is a perspective cross-sectional view of an embodiment of the present invention.

FIG. 24 is a perspective cross-sectional view of one embodiment of the present invention.

FIG. 25 is a perspective view of one embodiment of the present invention.

FIG. 26 is a perspective cross-sectional view of one embodiment of the present invention.

FIGS. 27A and 27B are cutaway perspective views of one embodiment of the present invention.

FIG. 28A is a perspective side view of one embodiment of the present invention.

FIG. 28B is a perspective side and cross-sectional view of one embodiment of the present invention.

FIG. 29A is a perspective cross-sectional view of one embodiment of the present invention.

FIGS. 30A and 30B are side cross-sectional views of one embodiment of the present invention.

FIG. 31A is a side perspective views of embodiments of the present invention.

FIG. 31B is a bottom view of an embodiment of the present invention.

FIGS. 32A and 32B are side perspective views of embodiments of the present invention.

FIGS. 33A-33C are side perspective views of embodiments of the present invention.

FIG. 33D is a bottom view of an embodiment of the present invention.

FIG. 34 is a side perspective view of an embodiment of the present invention.

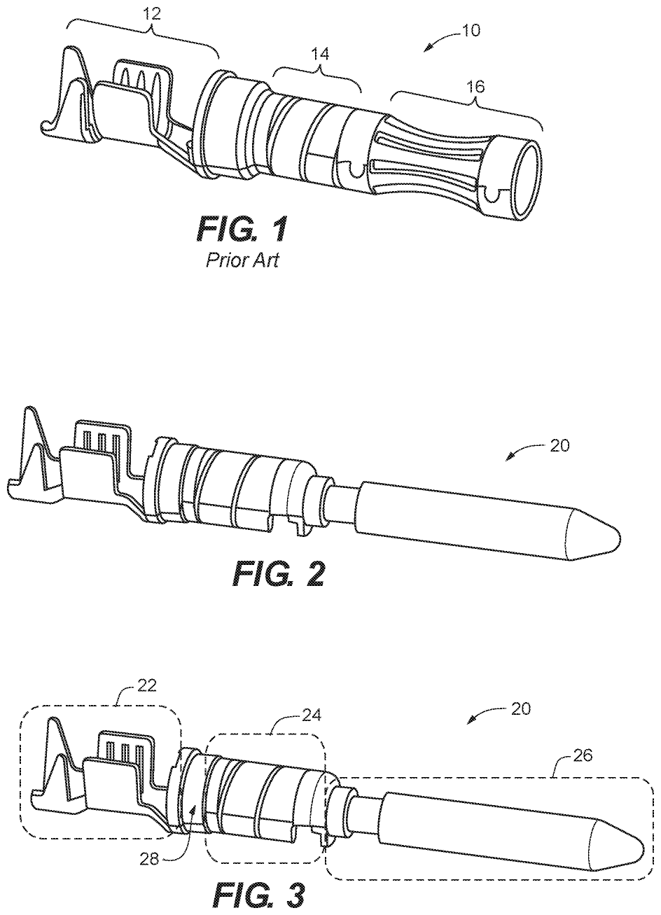

### DETAILED DESCRIPTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

Various embodiments of the present invention comprise improved flexible electrical contacts. FIGS. 2 and 3 illustrate one embodiment of a flexible electrical contact 20 comprising a connection region 22, flexible region 24 and turned interface region 26, wherein there is an unbroken annular contour 28 disposed between the flexible region 24 and the connecting region 22. The turned interface region 26 may comprise pins (male structures) and/or sockets (female structures) leading away from the flexible region 24.

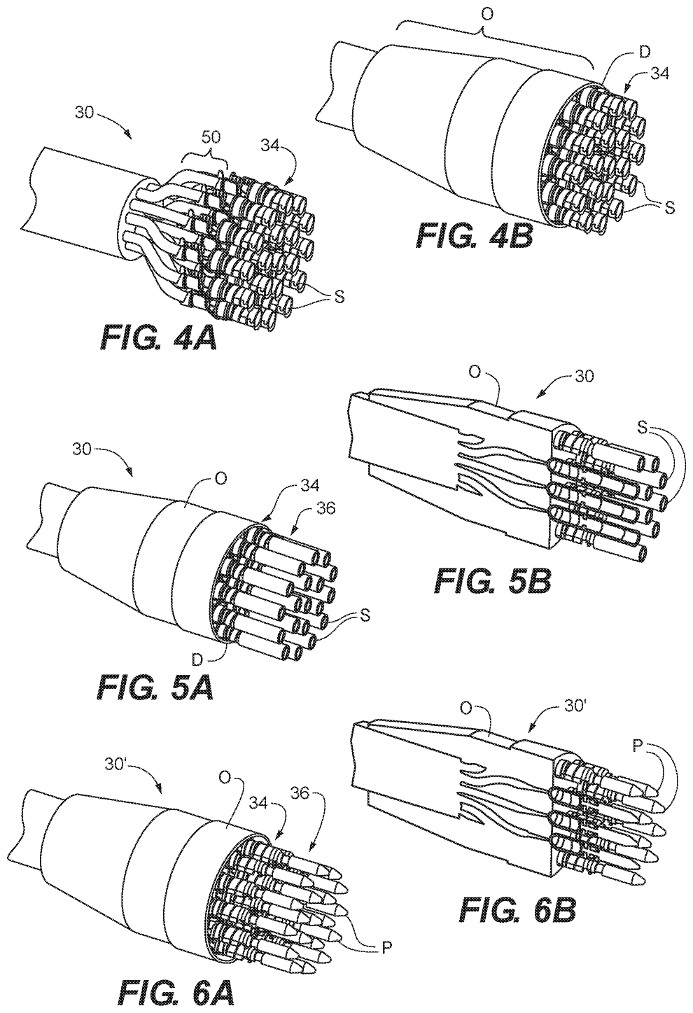

Turning to FIGS. 4A-4B, a flexible electric contact 30 is shown with a plurality of connection regions 32 and flexible regions 34 without interface regions installed. FIG. 4B comprises overmolding O disposed over at least a portion of the flexible regions 34. Flexible regions 34 extend a distance distally beyond a distal end D of overmolding O, though in other embodiments flexible regions 34 may not extend distally beyond distal end D of overmolding O. Thus, an array of combined connection/flexible regions 32, 34 are connected to conducting wires and placed, without interface regions, in an overmolding tool (not shown). FIG. 4B illustrates the array of contacts comprising connection and flexible regions 32, 34 in a thermoplast, thermoset, elastomer or ceramic overmold O. These electrically insulating and/or sealing overmolds O may be produced by any means including, but not limited to, injection molding, low or high pressure vulcanization, pouring or sintering.

FIGS. 5A and 5B illustrate the interface regions 36 comprising sockets S extending further away from flexible regions 34 and still further from a distal end D of overmolding O.

FIG. 5A shows the overmolded assembly from FIG. 4B, after the flexible regions 34 have been fitted with and, as an example, turned socketed interface regions containing a stamped and formed contact cage, which may also be constructed of a different base material and/or surface treatment than the turned socket interface sleeve, the flexible region, or any other region of the finished contact assembly.

FIGS. 6A and 6B show a flexible electric contact 30′ comprising a plurality of interface regions 36 wherein the interface regions comprise pins P adapted for operative connection with sockets S of electric contact 30. Thus, FIG. 6A shows the overmolded assembly from FIG. 4B, after the flexible regions have been fitted with, as an example, turned pin interface regions which may also be constructed of a different base material and/or surface treatment than the flexible region or any other region of the finished contact assembly.

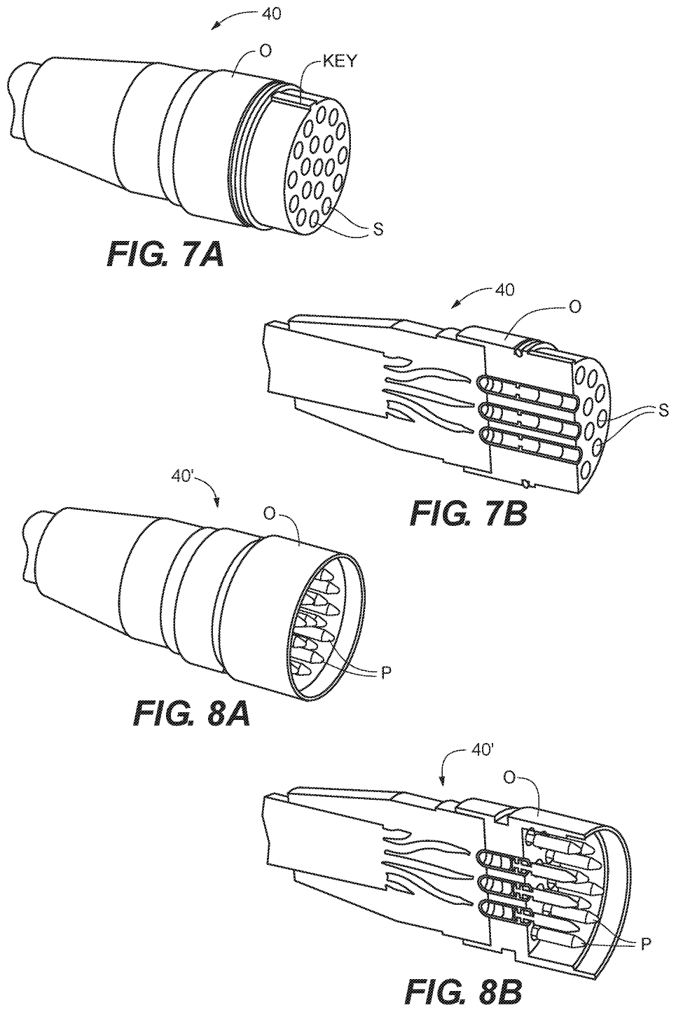

FIGS. 7A, 7B and 8A, 8B illustrate a connecting pair of flexible electrical contacts 40 and 40′, wherein the interface region of flexible electrical contact 40 comprises a plurality of sockets S adapted for operative receipt and engagement with the plurality of pins P of complementary flexible electrical contact 40′. As seen, contact 40 and 40′ are complementarily keyed to fit together in a particular orientation, with a distal region of contact 40 fitting within a distal region of contact 40′, thus enabling precise orientation of the pins P for insertion within sockets S. In the illustrated embodiments, the interface sections comprising sockets S disposed within a molded housing.

FIGS. 7A and 7B thus illustrate the assembly from FIG. 5A after being fitted with an additional insulation housing part in order to produce the socket-contact-side of an example electrical connector. The geometry of the additional insulation housing not only electrically isolates the contacts from each other, blocking surfaces on the volume containing the interface and/or flexible regions limit the movement of the interface region such that a translation and/or tipping is possible in the directions orthogonal to the connection direction along the center axis of the contact, however the movement of the interface region parallel to the connection direction is greatly limited either by a blocking surface or by the blocking of the flexible element against itself.

FIG. 8A shows showing the assembly from FIG. 6A after being fitted with an additional insulation housing part in order to produce the pin-contact-side of an example electrical connector. Note that the assemblies in FIGS. 7A and 8A, that is, both mating halves of an example electrical connection, are both derived from the sub-assembly shown in FIG. 4B.

The combination of the modular contacts according to the invention and the variable mating housings including possible overmolds and a wide variety of different types of contact interfaces, allows for geometry that would normally not be manufacturable by to other means to be produced using common tooling. This, in turn, results in reductions to the capital required in order to produce a wide variation of product types because the same tools are used for all product variations instead of each end product requiring its own set of tools. In turn, this allows for the economical and profitable manufacture of end product variations which would normally not be feasible due to their low production quantities because these low-volume product variants do not require customized tooling. Additionally, the overmolding and/or poured sealing processes require a great deal of time, therefore storing pre-assemblies in which the end product has not yet been determined allows for the faster delivery of end products as well as reduces the likelihood of pre-assemblies being stored for long periods of time.

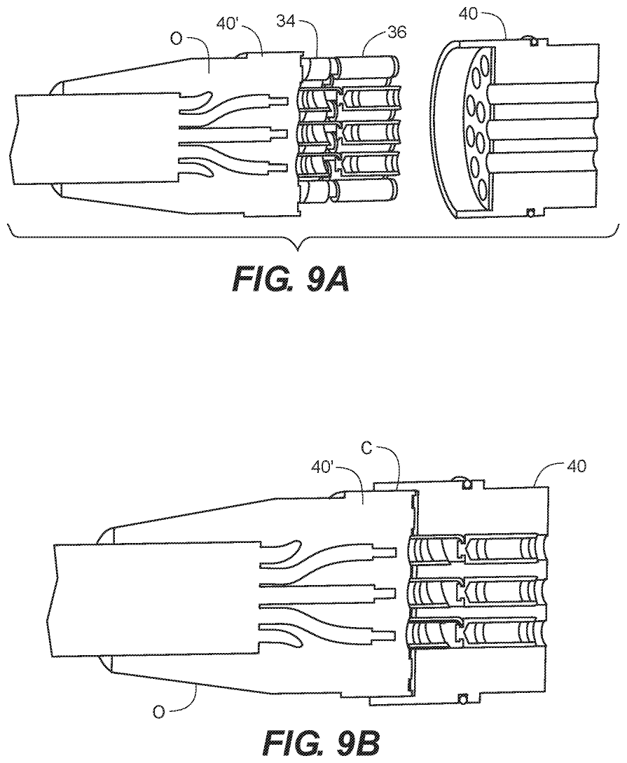

Turning to FIGS. 9A and 9B, the flexible electrical contacts 40, 40′ are shown as permanently or semi-permanently fixed to each other when connected as described in connection with FIGS. 7A-8B, with pins P inserted within sockets S, wherein pins P and sockets S are operatively attached to flexible regions 34 as describe above. Such operative fixation between contacts 40 and 40′ may be achieved by a snap connection or fitting, welding, gluing, a fastener such as a screwed connection, bayonet or other similar connection and/or fixture C. Moreover, seals may be provided between the contacts and/or between the housing parts when contacts 40 and 40′ are in the connected condition. The contacts may be further sealed and fixed in place by the plastic overmold O.

FIG. 9A is an illustration after the attachment of the exemplary modular contact interfaces, but before the installation of an additional insulating housing. FIG. 9B as shown in FIG. 9A, after the installation of an additional insulating housing, which details the possible sealing locations as well as a circumferential fixation between the two insulation parts that may be sealed through its fixation process or be fitted with an additional on-molded or installed seal between the insulating parts.

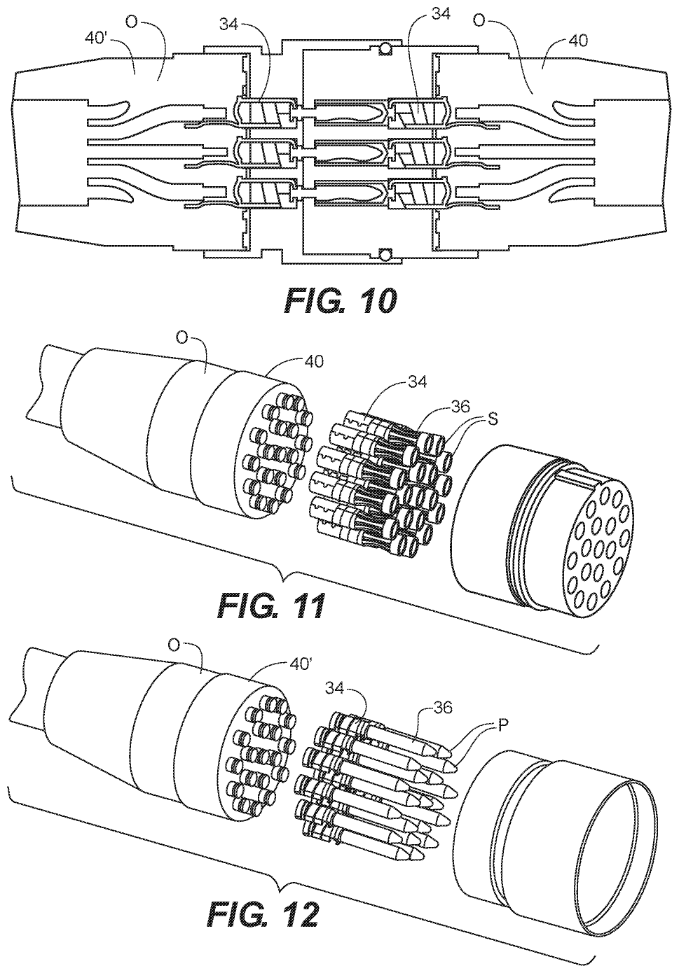

FIG. 10 provides a side cross-sectional view of the assembled connection between electrical contacts 40 and 40′ and comprising the flexible regions 34 operatively engaged with the interface region 36 within each contact 40, 40′, wherein pins P are disposed within sockets S.

Thus, FIG. 10 provides an example of the connectors in FIGS. 7A and 8A in the connected condition. This demonstrates that both connector sides are manufactured from the same sub-assembly consisting of the contact array fixed in their insulating housing before the interface section and/or the flexible region of the modular contact is fitted to the rest of the contact, consisting of the connection region and/or the flexible region.

Note that through the finishing of the contact assemblies after the overmolding process, the overmolded array of connection regions can be used for both sides of a particular electrical connection pair. That is, the overmolded array of connection regions shown in FIG. 4B can be used for both the side of the connection pair which contains socket contacts and the side of the connection pair which contains pin contacts.

FIGS. 11 and 12 are exploded illustrations of the parts of contacts 40 and 40′ wherein the flexible region 35 is integrated into the interface region 36, wherein the interface region 36 comprises, in the case of contact 40, sockets S and in the case of contact 40′, pins P.

FIG. 11 shows the connection region of the contact as a turned part and the modular socket contact interface region and flexible element of the contact as single and integrated with each other stamped and formed part.

FIG. 12 shows the connection region of the contact as a turned part and the modular pin contact interface region and flexible element of the contact as single and integrated with each other stamped and formed part.

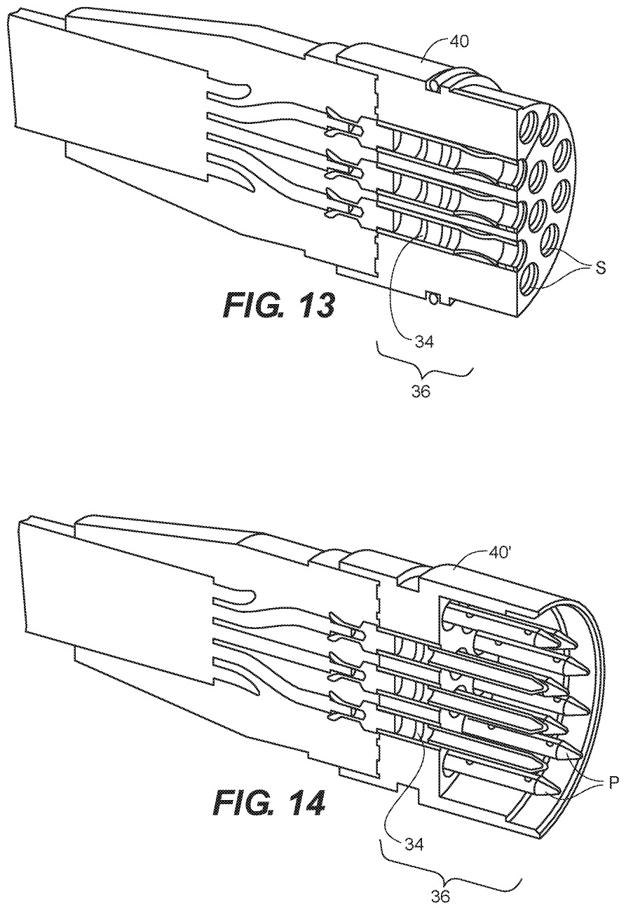

FIGS. 13 and 14 provide cross sectional illustrations of contact 40 and 40′, respectively, wherein the flexible region 34 is integrated with the interface region 36.

FIG. 13 illustrates the embodiment of FIG. 11 in its assembled state. It should be noted that a pull-relief of any type, such as screwed flanges, wrapped wires, clips, or compressive collars, may be installed on the cable before the overmolding process of the contact array and cable assembly in order to protect the integrity of the wires, the contacts, and the electro-mechanical connection between them should bending, pushing or pulling forces be applied to the cable.

FIG. 14 shows the embodiment of FIG. 12 in its assembled state. It should be noted that a pull-relief of any type, such as screwed flanges, wrapped wires, clips, or compressive collars, may be installed on the cable before the overmolding process of the contact array and cable assembly in order to protect the integrity of the wires, the contacts, and the electro-mechanical connection between them should bending, pushing or pulling forces be applied to the cable.

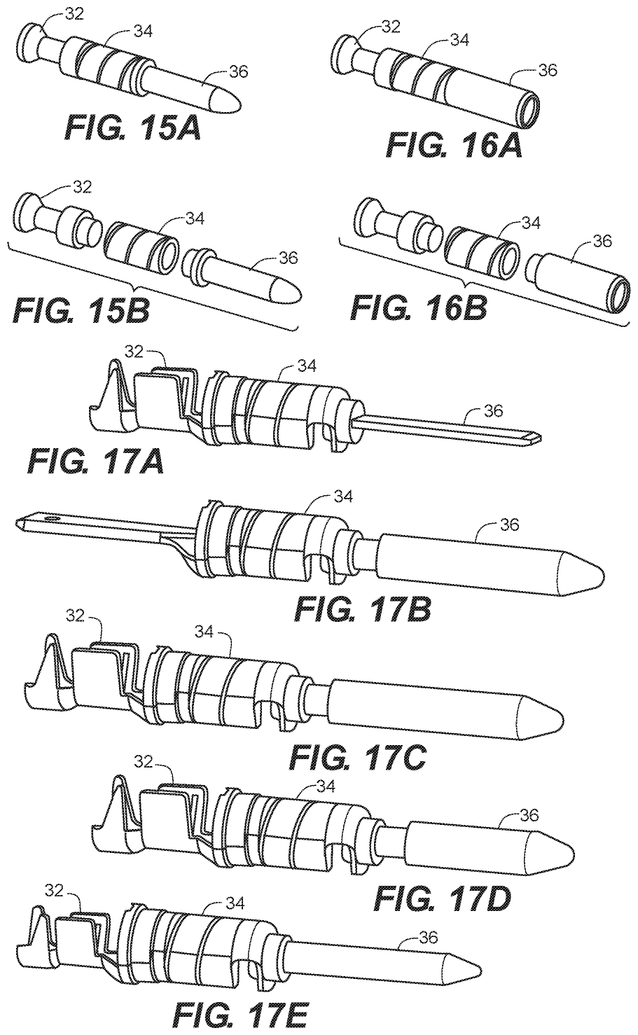

Turning now to FIGS. 15A-16B, exemplary contacts are shown with a separate connection region 32, separate flexible region 34 and a separate interface region 36, wherein connection region 32 and flexible region 34 are operatively connected and flexible region 34 is operatively connected with interface region 36. The connections may be press-fitted or laser welded or other equivalent connection means. The flexible region 34 may comprise a spring that may be round in cross-section or may comprise any shape in cross-section so long as it provides some degree of flexibility.

FIG. 15 A thus shows showing the connection, flexible, and interface regions as separate entities before the assembly process of the modular contact system. In their assembled state, as shown, a wide variety of contact combination can be achieved using a reduced number of common parts. In this example, all parts could be produced using different manufacturing methods such as turning, stamping and forming, sintering, printing or any other method of production.

FIG. 16A shows showing the connection, flexible, and interface regions as separate entities before the assembly process of the modular contact system. Note the common parts with the product variant shown in FIG. 15A.

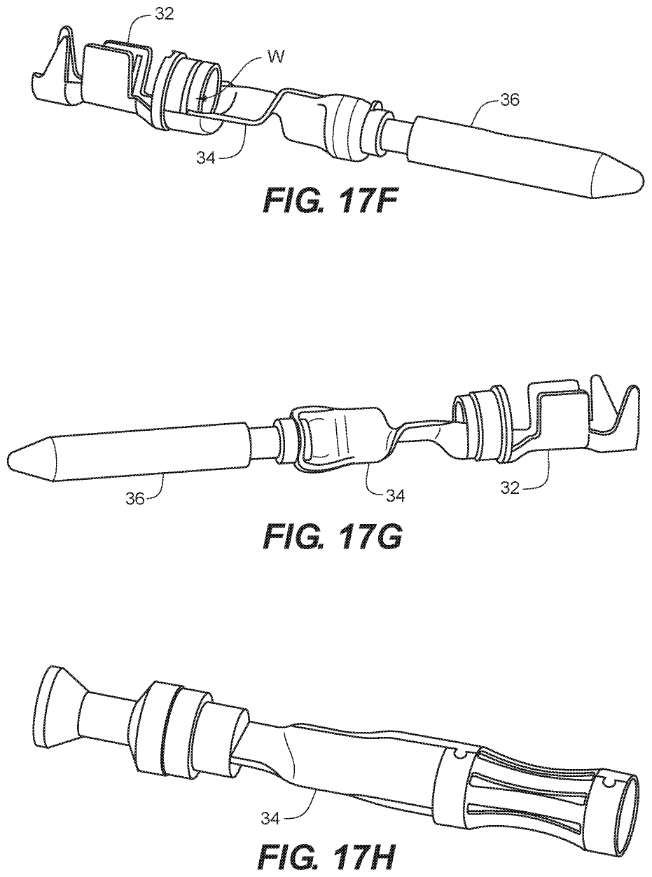

FIGS. 17A-17H provide examples of electrical contacts of the present invention showing some of the possible variations of the resulting end contact by means of the combination of the modular interface regions and connection regions, such as interface regions with varying shape, size and length as well as connection regions for the connection of wires of varying cross-section as well as connections of other types such as standardized flat connections or press-fit connections for metal plates or PCBs and connection regions for soldering. Also shown are differing types of flexible elements such as orthogonal flat springs and spiral springs, as well connection regions consisting of a turned part which has in turn been fitted with a flexible element and interface region at some point in its production process either prior to or after the overmolding process of the connection region. Thus, FIG. 17A provides a connection region 32, a flexible region 34 and an interface region 36 wherein the interface region 36 comprises an elongated flattened non-circular structure. This structure may require a keying or similar coding to ensure proper orientation of the interface region 36 when connected with complementary sockets as described above.

FIG. 17B shows a gap near the end of the flexible region proximate the connected interface region 36, wherein the gap allows a tool, e.g., a riveting tool, to fit inside the contact to deform the end of the pin.

FIGS. 17C-17E show variations of the flexible region 34 as a spiral-shaped structure.

FIG. 17F illustrates the contact with a casting window W dispose in the flexible region 34 to facilitate cast-sealing. FIGS. 17G and 17H show a contact comprising an orthogonal-flat spring shaped flexible region 36 and with an optional snapped-in place or riveted connection between the flexible region 34 and interface region 36. Two or more orthogonal-flat springs may be used to form the orthogonal-flat spring shaped flexible region 36.

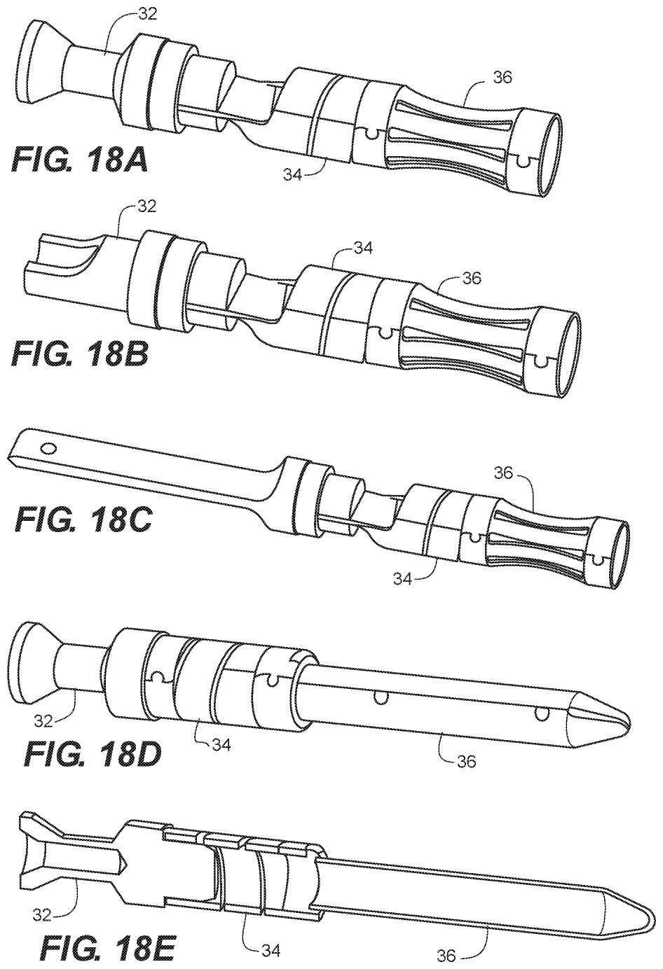

FIGS. 18A-18E provide further variations of contacts comprising a spiral-shaped flexible region 34 with connection region 32 and interface region 36 as illustrated. As may be seen, the connections between the regions 32, 34, 36 may be achieved by riveting, snapping, laser or resistance welding, crimping, press-fitting, gluing and/or soldering. Any permanent connection method may be used.

Thus, FIGS. 18A-18E show some of the possible variations of the resulting end contact by means of the combination of the modular interface regions and connection regions, by which the interface regions of varying shape, size and length are stamped and formed and the connection regions for the connection of wires of varying cross-section as well as connections of other types such as standardized flat connections or press-fit connections for metal plates or PCBs and connection regions for soldering are shown as solid parts created by turning, machining, stamping, sintering, or any other manufacturing process. The fitting of the connection region to the stamped and formed flexible element and interface region can be achieved by any means such as welding, press-fitting or riveting at some point in its production process either prior to or after the overmolding process of the connection region.

Thus, the contacts may be assembled before the insertion into the insulation housing via a press-fit or before the overmolding process.

Again, the flexible region 34 may be integrated with the interface region 36 in all variants or embodiments described herein, or may be a separate structure. Moreover, the flexible region 34 may be integrated with the connection region 32 or may be a separate structure.

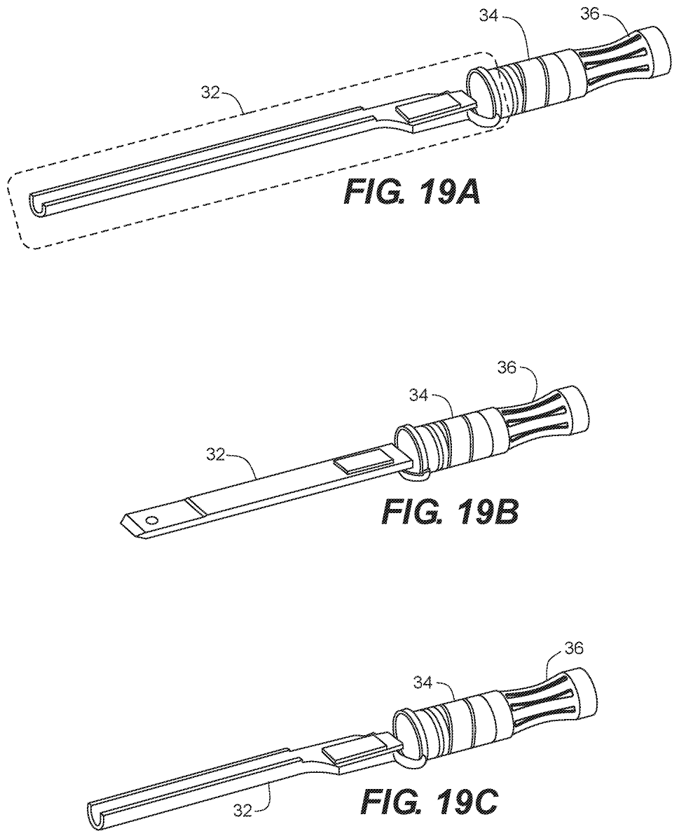

FIGS. 19A-19C show further variation of the contacts of the present invention, including a flattened or semi-circular connection region 32. FIGS. 19A-19C thus show variants of the contacts in which the connection region for soldered connections or with an integrated flat contact is fixed to the combined flexible region and interface region by means of resistance welding or riveting.

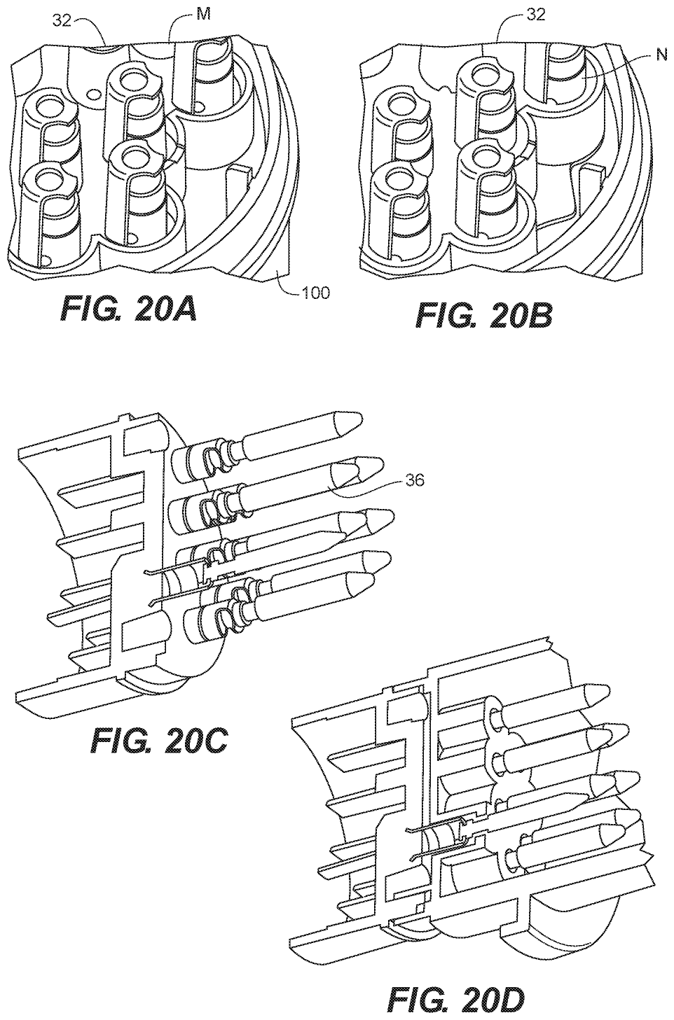

Turning now to FIGS. 20A and 20B, a window 100 in stamped-formed variants of the connection region 32 of the contacts 40, 40′ of the present invention the manifold surface M to be cast-sealed which increases the sealing of the contacts 40, 40′. In addition, a notch N for overflow and determining the depth of sealing may be provided. As shown in FIGS. 20C and 20D, the poured sealing material enters the interior volume of the contact through the window 100, flowing with gravity as shown. The interface region 36 may be added any time after the cast-sealing process is complete.

Thus, FIGS. 20A-20B show an embodiment in which the contacts and their overmolded insulation housing are designed to allow a poured casting process in order to provide an additional sealing to the sealing provided by the overmold. The contacts are fitted with a window, port or gap which allows a poured sealing compound to flow into the interior volume of the contacts as well as to enclose the outer contour of the contact with the sealing material. An outlet port on the overmolded insulating housing allows for the excess sealing compound to flow into a volume which does not impede the function of the assembly as well as sets the depth of the cast sealing material.

FIGS. 20C-20D show the state of the assembly after the casting process. Note that the sealing material has flowed into the inner volume of the contacts as well as completely enclosed the outer contour of the contact, resulting in a complete hermetic separation of the interface region of the contact from the connection region of the contact. The additional insulation housing in FIG. 20D limits the movement of the flexible regions as well as the interface region. Circumferential bosses on the contact chambers may press into the cast material after assembly of the forward insulation housing, providing a sealing between the contact chambers and ensuring that the direct clearance path between the electrical poles has been closed and the creepage path has been increased.

Advantages of this process are numerous:

The overmolding process is time intensive. By storing the assembly of the overmolded connection regions described above, orders may be filled faster when placed by the customer.

By matching different interface regions 36 and different connection regions 22, a high product variance may be achieved with reduced numbers of tools and storage infrastructure required.

The different regions 32, 34, 36 of the contact 40, 40′ may be made using different materials and different surface treatments to tailor the material properties to the function of the region 32, 34, 36. For example, a soft material for a crimped connection region 32 for improving the material contact in the crimped area may be combined with a relatively harder material in the interface region 36 to improve wear properties.

A solid part of the contact may act as an electrical dampener to reduce the negative effects of power surges.

If the contact consists of the combination of a turned region and a stamped-formed region, the stamped-formed portion of the contact can be left on the band in order to facilitate an automatic processing of the contacts.

The use of a turned connection region 32 reduces the required band material because the outer diameter of the overmolding interface does not need to be formed.

The use of a turned connection region 32 allows the overmolding pressure to be increased compared with known stamped and formed unbroken surface sets.

Processing time is lowered, bonding properties between the overmold and the base material are improved, and processing of complicated or delicate geometry in the insulation housing is facilitated and enabled.

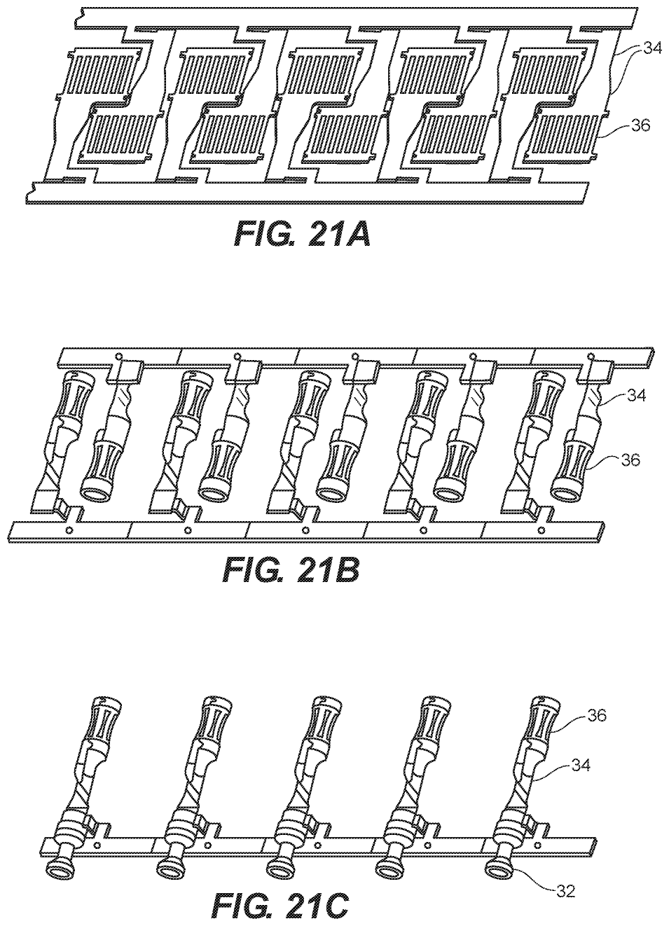

Turning now to FIGS. 21A-21C, a stamped part manufacturing process is provided with an orthogonal-flat-spring-shaped flexible region 34 integrated with the interface region 36 with subsequent connection of a connection region 32. In this way, any type of stamped part could be combined with at turned part on the band or after the separation of the stamped part from the band. For example, a stamped connection region 32 with an integrated flexible region 34 could be attached to a turned interface region 36 on the band or after the separation of the stamped connection region 32 from the band.

FIGS. 21A-21C illustrate therefore the manufacturing steps of the contact from the stamped flat band, to the band or bands after the forming process, to the attachment of a turned or machined connection region. This attachment may take place while the stamped parts are still connected to the band in order to facilitate an automated manufacturing process, or individually after the array of connection regions has been overmolded or otherwise affixed in an insulation housing.

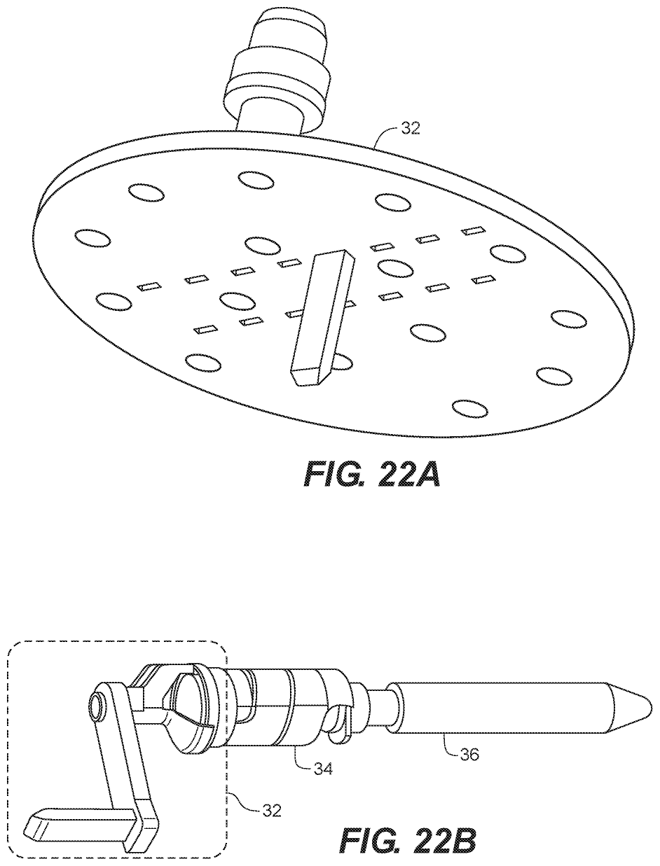

FIGS. 22A and 22B show an embodiment of the connection region 32 with a rear part of the connection region 32 shown as a flat contact. A printed circuit board (“PCB”) may in operative engagement with the connection region 32 and may be used for one or more than one of the contacts and may further contain electrical components to provide additional functions. It will now be appreciated that the connector region may comprise one or more sections and that each section may be connected with another section of the connection region by a PCB.

FIG. 22A thus shows a connection region inserted in a PCB, whereby the conduction path of the contact is offset and the connection region is completed as a flat contact interface. By this method, the contact pattern of the interface regions can be transferred to a different contact pattern for a secondary electrical connector. This is advantageous in situations when the electrical connector containing the flexible regions is used as a sacrificial connector in order to protect the secondary connector, using the fixed contacts attached to the PCB, from damage or corrosion.

FIG. 22B shows a stamped and formed connection geometry for insertion in a receptacle such as a bore in a PCB or a hole in a plate.

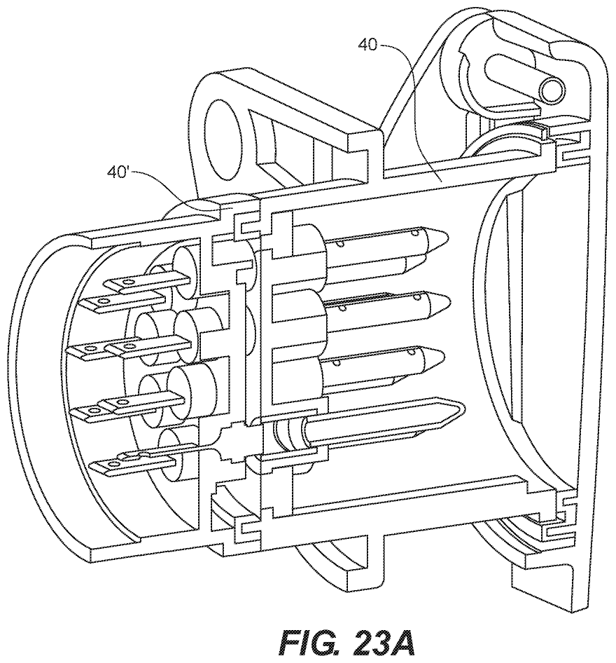

FIG. 23 illustrates in cross section a round, potted connector embodiment of an electrical contact 40′ positioned in connection with electrical contact 40 to form electrical connection as described above.

Thus, FIG. 23 shows an array of electrical contacts with integrated flat contacts as a connection region. The overmolded and cast sealed sub-assembly is permanently mated to a front housing assembly which is fitted with a spring-biased protective cover. An on-molded seal or other type of seal prevents moisture from entering the seam between the two housing parts, and in combination with the cast seal at the contacts or a sealed overmolding process, the electrical connector containing the contacts acc. to the invention is hermetically sealed in relation to the secondary electrical connector containing the flat contacts, such that no path can be traced from the volume containing the interface region of a contact to the connection region or the volume containing the connection region of the same contact.

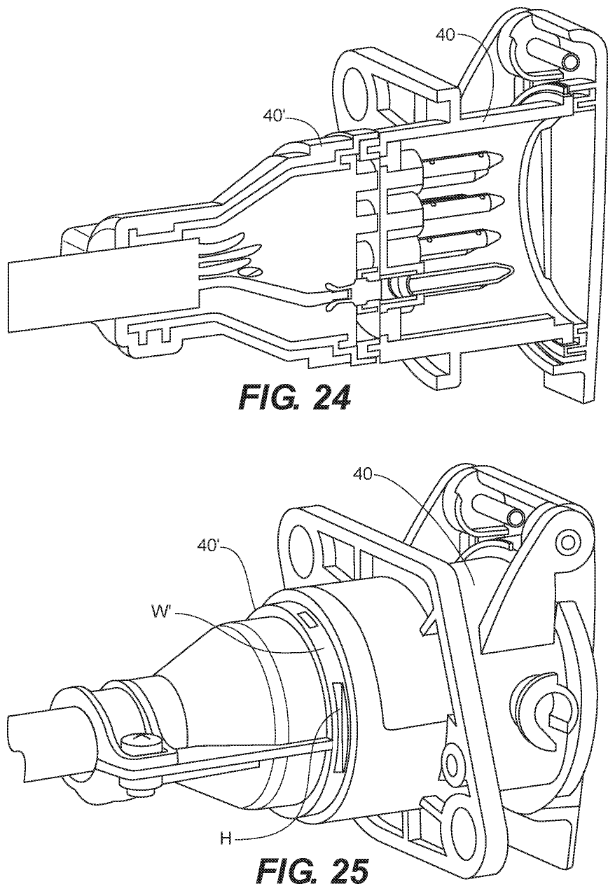

FIG. 24 illustrates another variation of an electrical connection comprising a cable connection with a rubber overmolded connection, shown in cross-section.

FIG. 24 therefore shows a rigid sub-structure which supports a pull-relief for the cable, placed in an overmolding tool with the contact array, and overmolded using a sealing process such as vulcanization with bonding agents. The rigid sub-structure protrudes from the elastomer overmold facilitating the attachment of the sub-assembly to the insulating housing with the spring-biased cover. This is advantageous because attachment methods between like materials are more numerous than attaching the elastomer overmold the insulating housing directly.

FIG. 25 illustrates a cable connection, rubber-overmolded electrical connector comprising contacts 40 and 40′, with rubber overmold to seal and windows W′ in the housing H to allow the rubber overmolding material to flow between the inside and outside of the housing H.

FIG. 25 thus shows the assembly from FIG. 24 with the elastomer overmold hidden. Note the ports in the rigid sub-structure which allow the elastomer overmold to flow to the contact array during the overmolding process so that the protrusion for fixation of the housings can remain circumferential and unbroken.

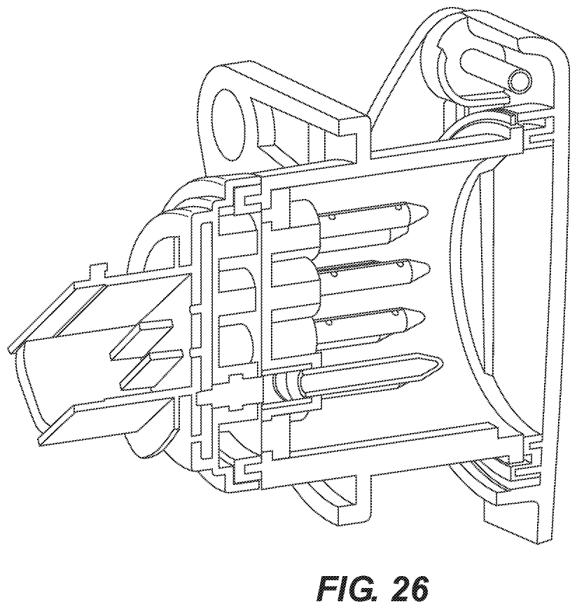

FIG. 26 illustrates the use of a PCB to create different connector region 32 interfaces. Thus, FIG. 26 shows a variation of the end product featuring a PCB which translates the contact pattern of the connector with, for example, round pin contacts to the contact pattern of the connector with, for example, flat contacts. This is particularly advantageous when one of both of the connectors cannot be changed due to a norm requirement or in order to maintain backward compatibility.

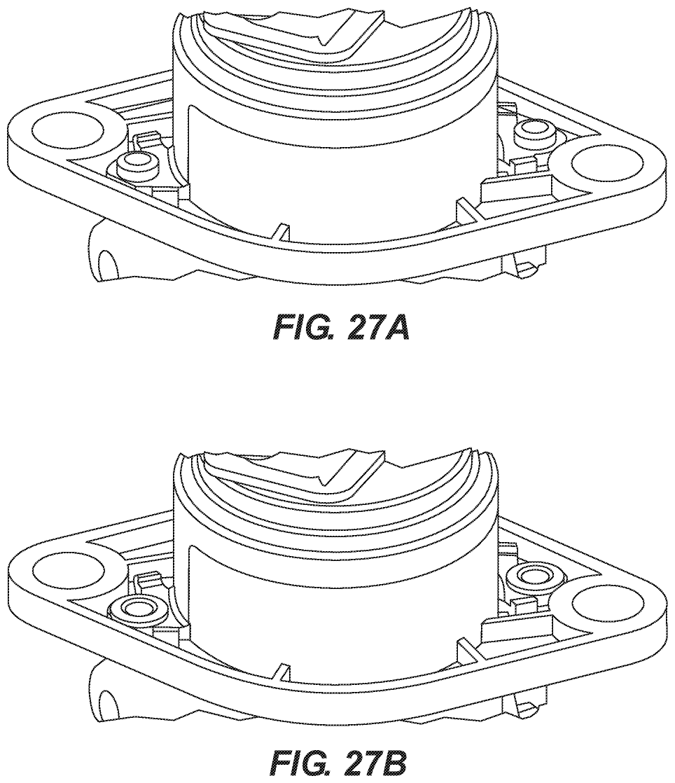

FIGS. 27A and 27B illustrate connection of the electrical contacts 40 and 40′ and/or sub-assemblies thereof, using heat stakes or ultrasonic rivets as shown as before deformation (not connected) and deformed (connected). These structures may also be connected using screws, snaps or other known fastener. FIGS. 27A-27B therefore show a connection of the insulation housings by means of a heat stake or ultrasonic deformation

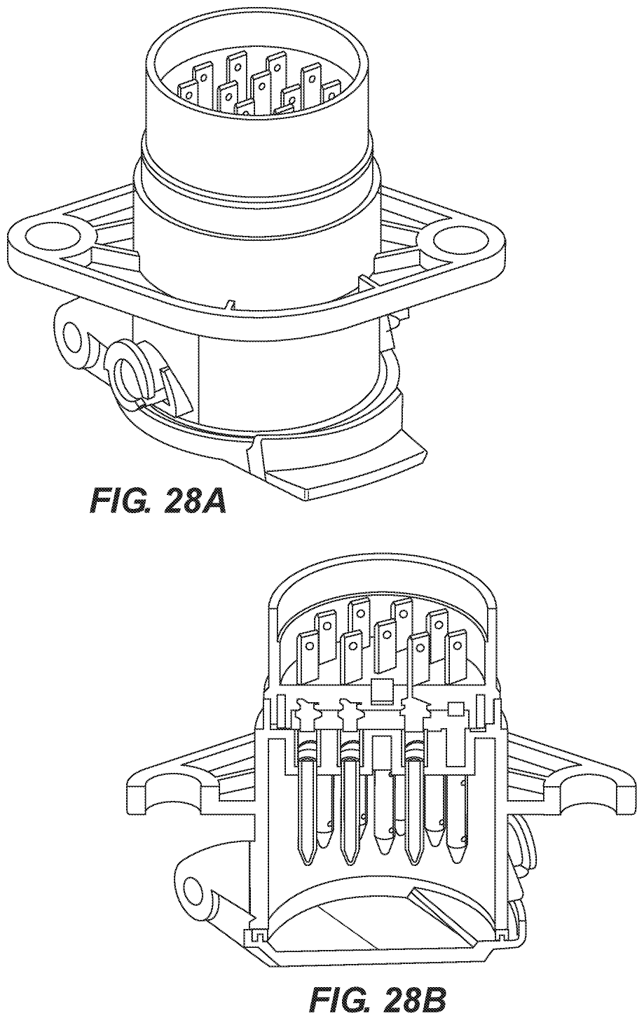

FIGS. 28A and 28B illustrate the connection of contacts 40 and 40′ using circumferential welding around the housing cylinder. FIGS. 28A-28B therefore show a connection of the insulation housings by means of a sealed or unsealed circumferential laser welding

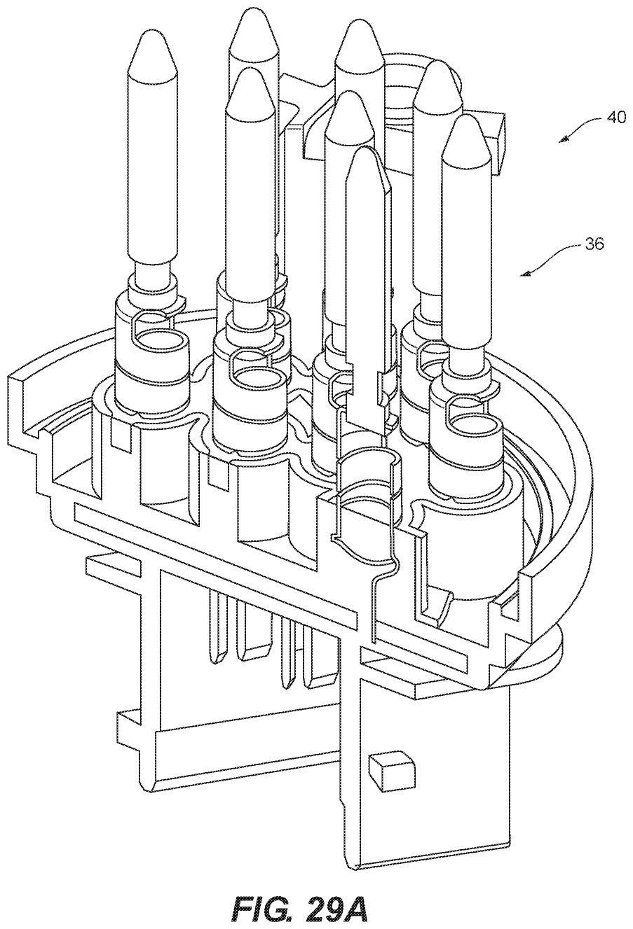

FIG. 29A is a cross-sectional view of the use of a poured cast seal on a subassembly of contact 40′ with a PCB and turned interface region 36.

FIG. 29A therefore shows an array of contacts whereby the connection region with an integrated flexible region is installed into a PCB and electrically connected to an array of flat contacts arranged in a different contact pattern. The sub-assembly of the PCB and contacts has been overmolded using a sealed or unsealed process and the contacts have been additionally sealed by means of a poured sealing compound. The interface regions are riveted to the flexible elements at any point in the production process, that is, before the connection regions are inserted into the PCB, after the overmolding process or after the casting process.

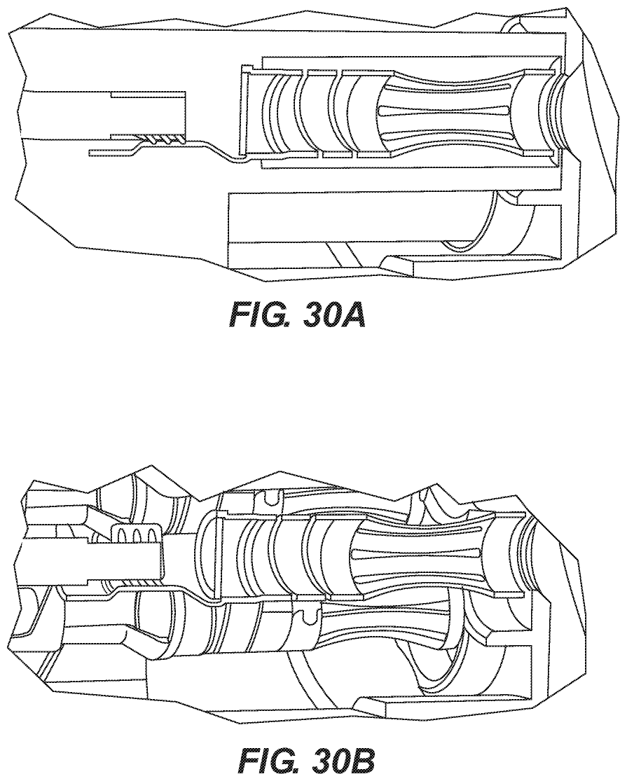

Turning now to an electrical contact with a flat region to enable sealing or bonding in FIGS. 30A-30B, illustrating the critical sealing areas in order to hermetically seal the wire cores. FIGS. 30A and 30B illustrate a cross-sectional view of a contact wherein the internal geometry is generally concave. Creating a chemical bond is difficult when such concave geometry exists. The overmolding material tends to pull away from the concave surface of the substrate as it cools, thereby impeding the creation or stabilization of the chemical bond between the two materials. In cases where a chemical bond is achieved in a concave geometrical structure, the concave geometry is susceptible to a degradation of the chemical bond through loading of the parts or temperature fluctuations.

As in FIGS. 30A and 30B, stamped and formed contacts often have concave geometry in the region between the attachment of the wire and the interface region of the two contact sides. Water cannot be permitted to reach the wire cores, thus the space between the attachment of the wire and the interface area of the contact is the region needing to be watertightly sealed. Degradation of the chemical bond leads to a reduction in sealing for reasons described supra.

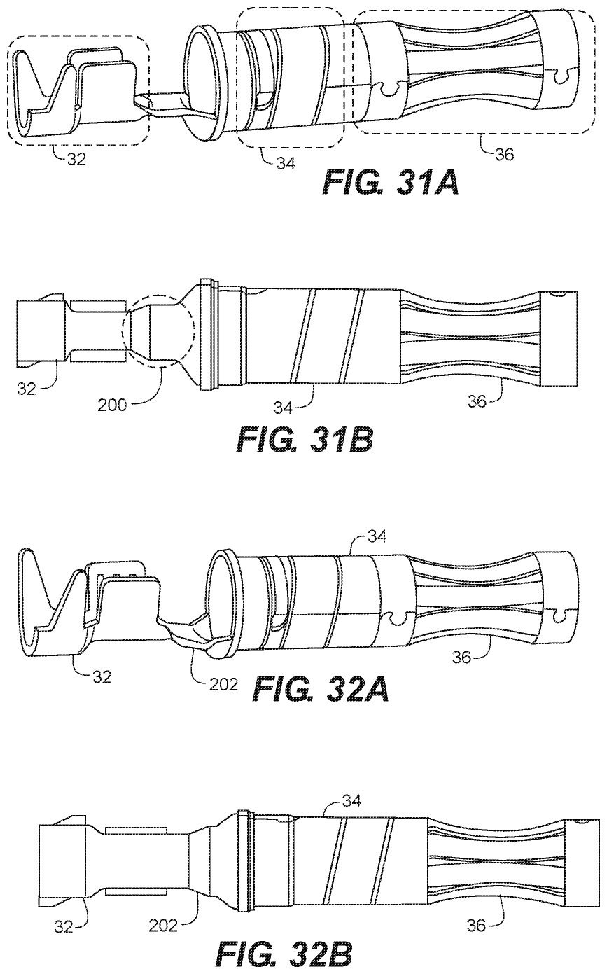

A solution to this problem has been discovered by inserting a flat sealing region of the stamped and formed contact between the interface region 36 and the connection region 34 of the contact 40, 40′. This eliminates all concave geometry and allows the outside of the flat portion of the contact to be sealed by gluing, potting or overmolding. This flat sealing region 200 is illustrated in FIGS. 31A and 31B and may be used in combination with any of the contacts 40, 40′ and/or electrical connections described herein. Further, as noted in FIG. 31A, the flexible region 34 is not required and may therefore be omitted.

The flat sealing region 200 may also be used in connection with a stamped and formed contact 40, 40′ and/or a contact 40, 40′ with a round pin. It is preferable to use the flat sealing region 200 with contacts 40, 40′ using a generally round cross-section, but it may be used with any type of geometry used for electrical contacts to assist in improving the efficacy of chemical bonding.

FIGS. 31A-31B show a variation of a flat region on the contact in order to improve chemical and mechanical bonding and sealing between the contact and the overmolding material.

Further, a sealing region 200 may be tapered but the sides cannot be concave. See FIGS. 32A and 32B for an exemplary non-straight sealing region 202 as a modification to the structure of FIGS. 31A and 31B. Thus, the tapered, non-concave sealing region 202 is at an angle to the centerline of the contact and tapered with straight, non-concave edges. Thus, FIGS. 31A-31B show a variation of a flat region on the contact in order to improve chemical and mechanical bonding and sealing between the contact and the overmolding material

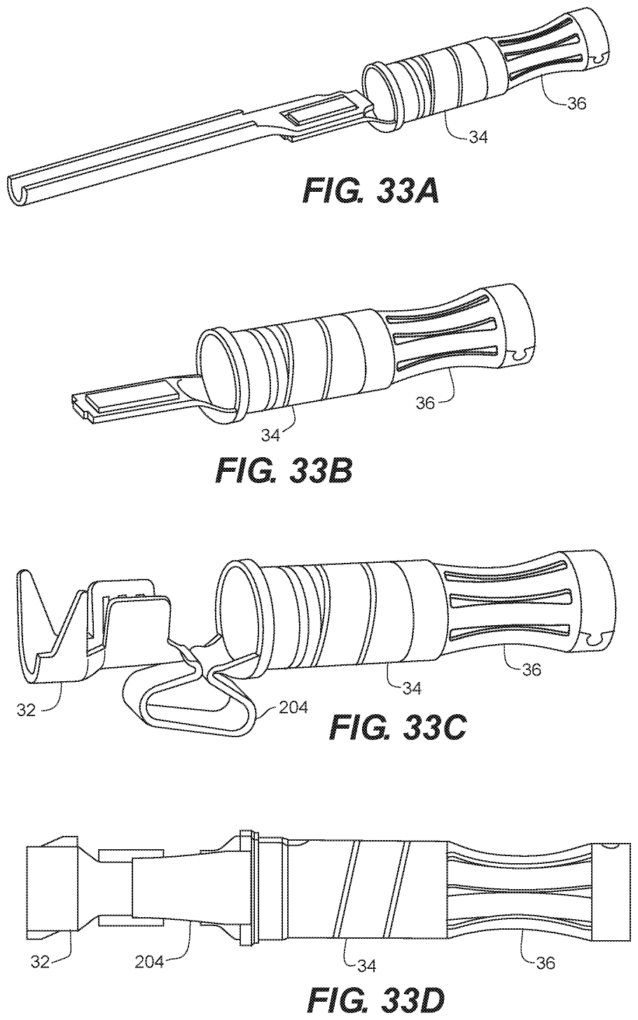

As shown in FIGS. 33A and 33B, the sealing region 200 may extend as far as necessary to facilitate the sealing by eliminating concave geometry. Further, as in FIGS. 33C and 33D, the flat sealing region 204 may be modified by offsetting it from the rest of the contact. Here the sealing region 204 is at an angle to the centerline of the contact, tapered with straight edges (non-concave) and offset for the rest of the contact in order to increase the length of sealing region 204. FIGS. 33A-33B thus show a variation of a flat region on the contact in order to improve chemical and mechanical bonding and sealing between the contact and the overmolding material

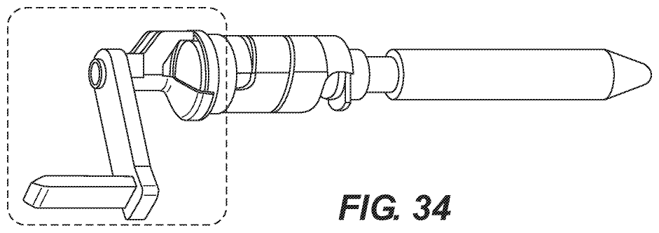

FIG. 34 illustrates a location for one of the sealing regions 200, 202, 204 in the stamped formed portion of the PCT connector discussed supra.

Examples of the types of electrical contacts covered by the above description include at least the following:

Example 1: An electrical contact for an electrical connector and comprising:
a connection region;
an interface region; and
a flexible region disposed between the connection region and the interface region,
wherein the flexible region is formed as one of the group consisting of a spiral spring with a rectangular cross-section and two or more flat springs oriented to each other at an angle,
wherein the connection region is a separate non-integrated part from the interface region,
wherein the connection region is unbroken, continuous and forming a watertight condition across the connection region, and
wherein the flexible region allows a movement of the interface region relative to the fixed connection region while maintaining the electrical connection between the connection region and the interface region.

Example 2: The electrical contact of example 1, further comprising the flexible region integrated as a single piece with either the connection region or the interface region.

Example 3: The electrical contact of one of examples 1-2, further comprising the flexible region and the connection region being made of different materials and/or different surface treatments.

Example 4: The electrical contact of one of examples 1-3, further comprising the flexible region and/or the interface region connected with the connection region after the connection region has been installed in an insulated housing or after the connection region has been overmolded in an insulating material.

Example 5: The electrical contact of one of examples 1-3, wherein the connection region, the flexible region and/or the interface region are connected by one or more of the group consisting of: riveting, snapping in place, laser welding, crimping, press fitting, resistance welding, gluing, and soldering after the connection region has been installed in an insulating housing or after the connection region has been overmolded in an insulating material.

Example 6: The electrical contact of one of examples 1-5, wherein at least one of the connection region, the flexible region and the interface region are stamped parts.

Example 7: The electrical contact of one of examples 1-6, wherein at least one of the connection region, the flexible region and the interface region are turned, sintered or machined parts on the band material.

Example 8: The electrical contact of one of examples 6-7, wherein the connection region, the flexible region and/or the interface region are connected by one or more of the group consisting of: riveting, snapping in place, laser welding, crimping, press fitting, resistance welding, gluing, and soldering while one of the stamped and formed contacted regions is still attached to each other on the band material.

Example 9: The electrical contact of one of examples 1-8, wherein the connection region comprises two or more sections that are connected by a printed circuit board.

Example 10: The electrical contact of one of examples 1-9 wherein a flat sealing region is disposed between the connection region and the interface region, wherein the contact does not comprise a flexible region.

Example 11: The electrical contact of one of examples 1-10 wherein a flat sealing region is disposed between the connection region and the flexible region.

Example 12: The electrical contact of one of examples 1-11, further comprising a casting window.

Example 13: The electrical contact of one of examples 1-12, further comprising the connection region having an continuous outer contour of any shape, larger than that of the outer contour of the interface region and/or flexible region, which in conjunction with an injection molding tool, contains the overmolding material during the overmolding process and prevents the overmolding material from encasing the geometry of the interface region and/or flexible region

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

1-13. (canceled)

14. An electrical contact for an electrical connector and comprising:
a connection region; an interface region; and
a flexible region disposed between the connection region and the interface region,
wherein the flexible region is formed as one of the group consisting of a spiral spring with a rectangular cross-section and two or more flat springs oriented to each other at an angle,
wherein the connection region is a separate non-integrated part from the interface region,
wherein the connection region is unbroken, continuous and forming a watertight condition across the connection region, and
wherein the flexible region allows a movement of the interface region relative to the fixed connection region while maintaining the electrical connection between the connection region and the interface region.

15. The electrical contact of claim 14, further comprising the flexible region integrated as a single piece with either the connection region or the interface region.

16. The electrical contact of claim 14, further comprising the flexible region and the connection region being made of different materials and/or different surface treatments.

17. The electrical contact of one of claim 14, further comprising the flexible region and/or the interface region connected with the connection region after the connection region has been installed in an insulated housing or after the connection region has been overmolded in an insulating material.

18. The electrical contact of claim 14, wherein the connection region, the flexible region and/or the interface region are connected by one or more of the group consisting of: riveting, snapping in place, laser welding, crimping, press fitting, resistance welding, gluing, and soldering after the connection region has been installed in an insulating housing or after the connection region has been overmolded in an insulating material.

19. The electrical contact of claim 14, wherein at least one of the connection region, the flexible region and the interface region are stamped parts.

20. The electrical contact of claim 14, wherein at least one of the connection region, the flexible region and the interface region are turned parts on the band material.

21. The electrical contact of claim 19, wherein the connection region, the flexible region and/or the interface region are connected by one or more of the group consisting of: riveting, snapping in place, laser welding, crimping, press fitting, resistance welding, gluing, and soldering while one of the stamped and formed contacted regions is still attached to each other on the band material.

22. The electrical contact of claim 14, wherein the connection region comprises two or more sections that are connected by a printed circuit board.

23. The electrical contact of claim 14, further comprising a flat sealing region disposed between the flexible region and the connection region.

24. The electrical contact of claim 14, further comprising the electrical contact not having a flexible region and comprising a flat sealing region disposed between the connection region and the interface region.

25. The electrical contact of claim 14, further comprising a casting window disposed in the flexible region.

26. The electrical contact of claim 14, further comprising the connection region having an continuous outer contour of any shape, larger than that of the outer contour of the interface region and/or flexible region, which in conjunction with an injection molding tool, contains the overmolding material during the overmolding process and prevents the overmolding material from encasing the geometry of the interface region and/or flexible region.
